(19) United States
(12) Patent Application Publication
(10) Pub. No.: US 2012/0067756 A1
(43) Pub. Date: Mar. 22, 2012

(54) INTERACTIVE BEVERAGE STORING AND DISPENSING APPARATUS AND METHOD

(76) Inventor: Michael E. Jansen, Agoura Hills, CA (US)

(21) Appl. No.: 13/251,787

(22) Filed: Oct. 3, 2011

Related U.S. Application Data
(63) Continuation-in-part of application No. 29/361,075, filed on May 5, 2010, now Pat. No. D646168.

(51) Int. Cl. B65D 25/02; B67D 1/08; B23P 17/00

(52) U.S. Cl. 206/457; 29/592; 222/1

(57) ABSTRACT

A beverage storing and dispensing system having an interactive display.

### CROSS-REFERENCE TO RELATED APPLICATION

This Patent Application claims priority to U.S. patent application Ser. No. 29/361,075 filed May 5, 2010, the entire contents of which is incorporated herein by reference in its entirety.

### BACKGROUND OF THE INVENTION

1. Field

Embodiments of the present invention relate to beverage storage and dispensing containers. More particularly, embodiments of the present invention relate to a beverage storage and dispensing container system having an interactive ornamental display.

2. Discussion of Related Art

There are many types of containers available to store and dispense beverages. Conventional containers are almost identical and typically include a removable lid operable to seal a beverage in a cavity defined by the container. To dispense the beverage, the lid is removed from the container. While conventional containers are adequate for storing and dispensing beverages, conventional containers do not provide any additional functionality. Often times, conventional containers, particularly those containing alcoholic beverages, are stored in highly-visible areas, such as on bar shelves and counter tops.

Accordingly, there is a demand for a beverage storage and dispensing system with a relatively improved appearance and additionally functionality.

### SUMMARY OF THE INVENTION

The following brief description is provided to indicate the nature of the subject matter disclosed herein. While certain aspects of the present inventive concept are described below, the summary is not intended to limit the scope of the present inventive concept. Embodiments of the present inventive concept provide a system for framing and displaying pictures, documents, and/or other visual media, and a method of manufacturing such a system. The present inventive concept does not suffer from and remedies the deficiencies of conventional devices such as those previously set forth herein. The present inventive concept provides, in its simplest form, a container, a closure to seal the container, and a stand to support the container. The container houses a beverage, a fixed ornamental display, and a plurality of non-fixed visible particles that interact with and circulate around the ornamental display when the beverage is circulated within the container. The container is operable to (i) store the beverage, (ii) dispense the beverage, and (iii) provide a holiday scene when the beverage is dispensed therefrom.

The aforementioned may be achieved in one aspect of the present invention by providing a beverage storage and dispensing system with display. The system may include a container having an inner wall and an outer wall that cooperatively define a cavity, and at least one opening through the inner and outer walls operable to permit dispensing of the beverage from the container, an ornamental structure housed within the cavity of the container and secured therein via a fastening means, and/or a plurality of particles housed within the cavity of the container, the plurality of particles operable to circulate within the cavity and around the ornamental structure when the container is moved. The plurality of particles may be edible and/or cooperates with the ornamental structure to provide a scene when the container is moved.

The system may also include a stand having a container-receiving surface and a planar-bottom surface opposite to the container-receiving surface. The stand may be operable to support the container. The container-receiving surface may be recessed within the stand. The fastening means may be a magnetic system operable to permit selective separation of the ornamental structure from the container and/or a stand when the ornamental structure is subject to a force, such as a pulling force. The fastening means may include a first fastening component in the ornamental structure and a second fastening component in the container-receiving surface of the stand. The first fastening component and/or the second fastening component may be one of a magnet and a magnetically-attractive component.

The system may also include a second opening through the inner and outer walls on a side of the container opposite to the at least one opening, the second opening operable to permit removal of the ornamental structure therethrough. The system may also include a stand having a container-receiving surface and a planar-bottom surface opposite to the container-receiving surface, the stand operable to support the container and close the second opening when the stand is secured to the container. The system may also include a closure sized and shaped to be fitted to the container so that a seal is formed when the closure is fitted to the container. The fastening means may include a first fastening component in the ornamental structure and a second fastening component in the closure.

The aforementioned may be achieved in another aspect of the present invention by providing a method of manufacturing a beverage storage and dispensing system with display. The method may include the steps of forming a container having an inner wall and an outer wall that cooperatively define a cavity, forming at least one opening through the inner and outer walls operable to permit dispensing of the beverage from the container, housing an ornamental structure housed within the cavity of the container and securing the ornamental structure within the cavity via a fastening means, and/or housing a plurality of particles within the cavity of the container, the plurality of particles operable to circulate within the cavity and around the ornamental structure when the container is moved. The plurality of particles may be edible and/or cooperates with the ornamental structure to provide a scene when the container is moved.

The method may further include the step of supporting the container on a stand having a container-receiving surface and a planar-bottom surface opposite to the container-receiving surface. The container-receiving surface may be recessed within the stand. The fastening means may be a magnetic system. The fastening means may include a first fastening component in the ornamental structure and/or a second fastening component in the container-receiving surface of the stand. The first fastening component and/or the second fastening component may be one of a magnet and a magnetically-attractive component.

The method may further include the step of forming a second opening through the inner and outer walls on a side of the container opposite to the at least one opening. The second opening may be operable to permit removal of the ornamental structure therethrough. The method may further include the step of providing a stand having a container-receiving surface and a planar-bottom surface opposite to the container-receiving surface. The stand may be operable to support the container and close the second opening when the stand is secured to the container.

The aforementioned may be achieved in another aspect of the present invention by providing a method of storing and dispensing a beverage. The method may include the steps of storing a beverage in a cavity of a container, the container having an inner wall and an outer wall that cooperatively define the cavity, storing an ornamental structure within the cavity of the container and securing the ornamental structure within the cavity via a fastening means; and/or storing a plurality of particles within the cavity of the container. The plurality of particles may be operable to circulate within the cavity and around the ornamental structure when the beverage is dispensed from the container.

Additional aspects, advantages, and utilities of the present invention will be set forth in part in the description which follows and, in part, will be obvious from the description, or may be learned by practice of the present invention.

### BRIEF DESCRIPTION OF THE DRAWINGS

Embodiments of the present invention are described in detail below with reference to the attached drawing figures, wherein:

FIG. 1 is a perspective view of a beverage dispensing system in accordance with an exemplary embodiment of the present invention;

FIG. 2 is an exploded view of the beverage dispensing system illustrated in FIG. 1;

FIG. 3 is an elevated cross-sectional side view of the beverage dispensing system illustrated in FIG. 1, illustrating a mouth at a top of the system;

FIG. 4 is an elevated cross-sectional side view of the beverage dispensing system illustrated in FIG. 1, illustrating a narrow mouth at a bottom of the system; and

FIG. 5 is an elevated cross-sectional side view of the beverage dispensing system illustrated in FIG. 1, illustrating a wide mouth at a bottom of the system.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

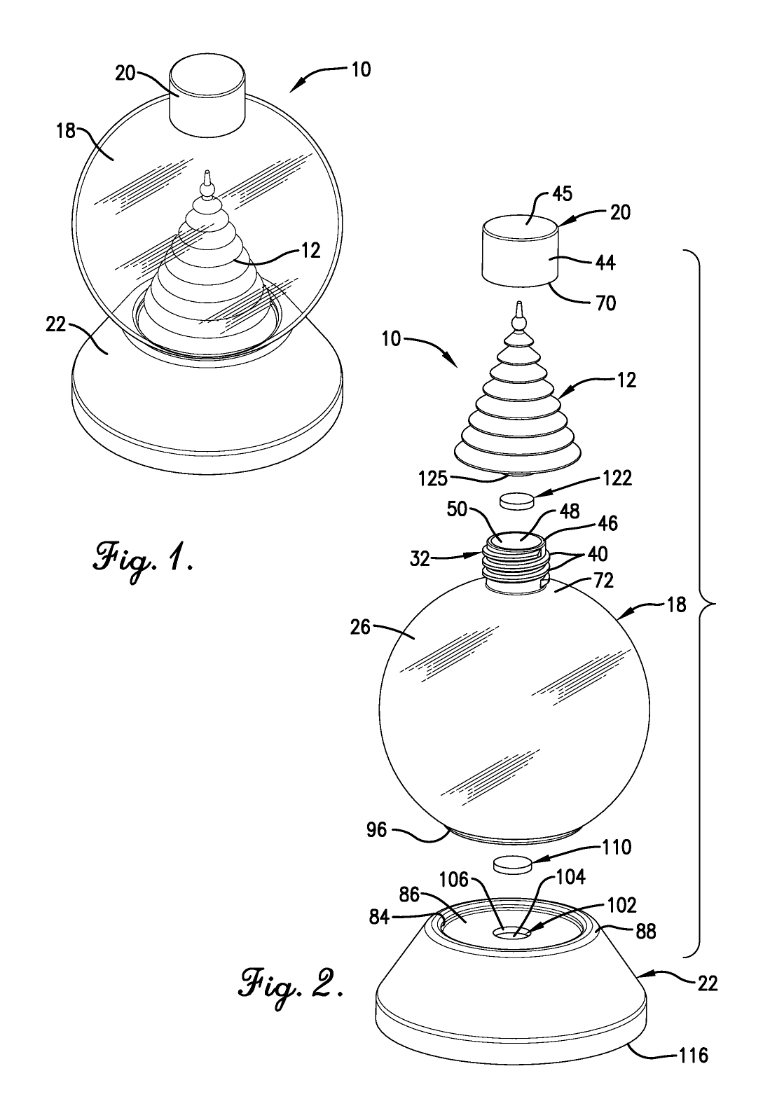

Turning to the drawings and particularly FIGS. 1 and 2, a beverage dispensing system 10 having a display 12 housed therein is illustrated. The system 10 generally includes a transparent container 18 having a closure or cap 20 operable to sealingly engage the container 18, and a stand 22 operable to securely support the container 18. In this manner, the system 10 is operable to store an ingestible fluid 24 in the container 18, such as alcohol or the like, display the display 12 housed in the container 18, and/or dispense the fluid 24 from the container 18.

The container 18 is spherical or globe-shaped and includes an outer surface 26 and an opposing inner surface 28 that cooperatively define a container cavity 30 within the container 18. The container cavity 30 is sized and shaped to store the fluid 24 within the container 18 and is made of a transparent or semi-transparent material, such as, but not limited to glass, plastic, or a combination thereof, to permit viewing of the fluid 24 and the display 12 housed within the system 10. In the exemplary embodiment, the container 18 is made of glass.

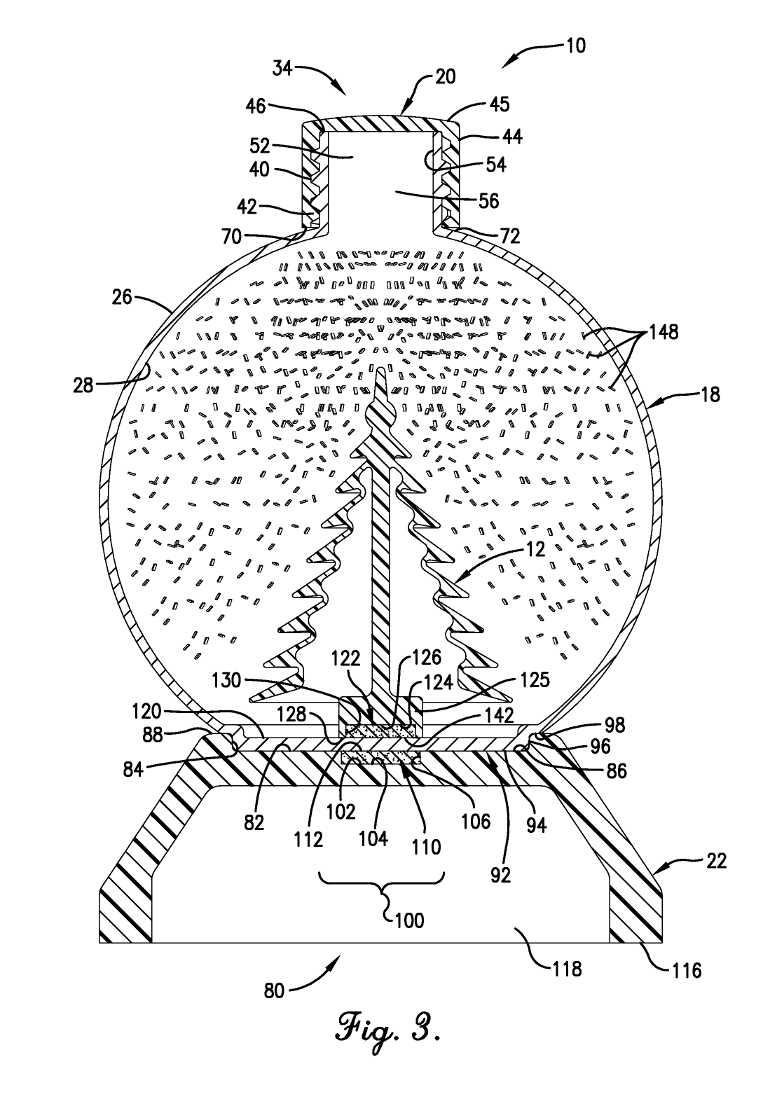

An extension or tubular neck 32 extends from the outer surface 28 of the container 18 at an upper end 34 thereof. The neck 32 is sized and shaped to securely receive the cap 20 thereon so that a seal is formed between the container 18 and the cap 20 when the cap 20 is secured to the neck 32. The neck 32 includes an outer threaded surface 40 that is sized and shaped to mate with a correspondingly sized and shaped inner threaded surface 42 on a skirt 44 that depends from a top wall 45 of the cap 20, as illustrated in FIG. 3. The threaded surfaces 40, 42 are operable to further secure the seal between the container 18 and the cap 20 when the cap 20 is secured to the neck 32.

At an uppermost edge 46 of the neck 32 is a mouth 48, which defines a fluid-access opening 50. Depending from the uppermost edge 46 of the neck 32 on an inside 52 of the neck 32 is a smooth inner surface 54. The smooth inner surface 54 extends parallel to the outer threaded surface 40 from the uppermost edge 46 to the inner surface 28 of the container 18 and defines a neck cavity 56 of the neck 32. The neck cavity 56 adjoins with the container cavity 30 to permit delivery of the fluid 24 stored in the container 18 to an outside of the system 10 for consumption by a user. The cavities 30, 56 define an entire interior area 58 of the system 10. The neck 32 is of a sufficient size and shape to allow the fluid 24 to be dispensed through the mouth 48 via the neck cavity 56 at a sufficient delivery rate for consumption, e.g., pouring into a glass or drinking directly from the system 10. It is foreseen that the neck 32 may be of any one of a variety of different sizes and/or shapes with larger sizes providing a higher delivery rate and smaller sizes providing a lower delivery rate. The neck 32 is made of a material that may be the same material, a different material, or a combination thereof that the container 18 is made of, such as, but not limited to glass, plastic, metal, or a combination thereof. In the exemplary embodiment, the neck 32 is made of glass.

The skirt 44 of the cap 20 includes an outer surface 68 that depends from the top wall 45 opposite to the inner threaded surface 42. A lower edge 70 spaces the surfaces 42, 68 at lower ends thereof. When the cap 20 is securely engaged on the neck 32 of the container 18 via screwing or a snap fit, the lower edge 70 of the cap 20 abuts an uppermost portion 72 of the container 18. In the exemplary embodiment, the cap 20 is made of plastic. It is foreseen, however, that the cap 20 may be made of metal or the like without deviating from the scope of the present inventive concept.

The stand 22 is secured to the container 18 at a lower end 80 thereof. The stand 22 includes a container receiver 82 having circumferential sidewall 84 that spaces a recessed surface 86 from a perimeter edge 88 of the stand 22. The container receiver 82 is sized and shaped to nestably receive a base 92 of the container 18 therein. The base 92 includes a protruding surface 94 having a circumferential sidewall 96 that respectively abut the recessed surface 86 and the circumferential edge 84 of the base 92 when the container 18 is nested in the stand 22. When the container 18 is securely engaged on the stand 22 of the container 18, the perimeter edge 88 of the stand 22 abuts a stand-abutment surface 98 of the container 18. The stand-abutment surface 98 is circumferential and is spaced from the protruding surface 94 of the container 18 by the circumferential sidewall 96 of the container 18. In the exemplary embodiment, the container 18 and the stand 22 are secured together via friction fit. It is foreseen, however, that the container 18 and the stand 22 may be secured together without fastening means, such as via a loose fit using gravity, and/or with fastening means, such as via an adhesive applied on one or more of the surfaces 84, 86, 94, 96, screws, a nut and bolt assembly, or the like, without deviating from the scope of the present inventive concept.

In a centermost region 100 of the recessed surface 86 of the stand 22 of the system 10 is a first fastener receiver 102 having a recessed surface 104 and a circumferential sidewall 106. The circumferential sidewall 106 spaces the recessed surface 104 of the first fastener receiver 102 from the recessed surface 86 of the container receiver 82. The first fastener receiver 102 is sized and shaped to entirely receive a first fastening component 110. When the first fastening component 110 is nested in the first fastener receiver 102, the first fastening component 110 has a first exposed abutment surface 112 that is flush with the recessed surface 86 of the container receiver 82. The first fastening component 110 is secured within the first fastener receiver 102 via a friction fit. It is foreseen, however, that the first fastening component 110 may be secured within the first fastener receiver 102 via an adhesive placed on one or more of the surfaces 104, 106 and/or the first fastening component 110 without deviating from the scope of the present inventive concept. In the exemplary embodiment, the first fastening component 110 is disk-shaped and made of a magnetically-attractive material, such as metal or the like. It is foreseen, however, that the first fastening component 110 may be a magnet without deviating from the scope of the present inventive concept.

The stand 22 includes a lower circumferential abutment edge 116 that is operable to support the system 10 when the system 10 is placed on a horizontal surface, such as a table-top surface, such as a desk, a shelf, or the like. In the exemplary embodiment, the stand 22 is made of a material having sufficient strength, such as plastic, wood, metal, or the like, to permit the stand to have a hollow interior 118. It is foreseen, however, that the hollow interior 118 of the stand 22 may by omitted from the system 10 so that the stand 22 has a solid interior without deviating from the scope of the present inventive concept. In the exemplary embodiment, the stand 22 is made of plastic.

The display 12 is operable to expand and contract when subjected to a force and is made of a compressible material, such as plastic or the like. In this manner, the display 12 may be received by and removed from the container 18 via the neck 32. The display 12 provides a scene having a theme and is selectable from one of a plurality of optional scenes. The system 10 may be provided with one or more of a plurality of various exchangeable display options for the display 12 that may be selected depending on a preference of the user, for instance, depending on a season or other application of the system 10. For illustrative purposes, the system 10 is illustrated with a single display option for the display 12.

The display 12 is fixed within the system 10 either permanently or removable, for example, to permit exchange of the display 12 for increased versatility of the system 10, without deviating from the scope of the present inventive concept. In the exemplary embodiment, the system 10 provides a single option for the display 12, which is shaped like a Christmas tree to provide a holiday scene. It is foreseen, however, that the display 12 may by of any size and/or shape to provide any one or more of a plurality scenes without deviating from the scope of the present inventive concept.

The display 12 is housed in the container cavity 30 and is removably mounted to an inner surface 120 of the base 92 via a second fastening component 122 that interacts with the first fastening component 110. The second fastening component 122 is installed in a second fastener receiver 124 in a connector 125 on the display 12. The second fastener receiver 124 includes a recessed surface 126 that is spaced from a bottom surface 128 of the display 12 via a circumferential sidewall 130. The second fastening component 122 is installed within the second fastener receiver 124 via a friction fit or the like with a second exposed abutment surface 142 being flush with the bottom surface 128 of the display 12 and exposed therefrom. It is foreseen, however, that the second fastening component 122 may be secured within the second fastener receiver 124 via an adhesive placed on one or more of the surfaces 126, 130 and/or the second fastening component 122 without deviating from the scope of the present inventive concept. In the exemplary embodiment, the second fastening component 122 is a disk-shaped magnet made of a magnetic material. It is foreseen, however, that the second fastening component 122 may be made of a magnetically-attractive material such as metal or the like without deviating from the scope of the present inventive concept.

When the first and second fastening components 110, 122 are respectively nested in the first and second fastener receivers 102, 124, and the display 12 is secured to the stand 22, the first and second fastening components 110, 122 are magnetically attracted to each other and form a magnetic bond through the container 18, which causes the display 12 to be removably secured to the inner surface 120 of the container 18 in an upright orientation. The first and second exposed abutment surfaces 112, 142 facilitate formation of the magnetic bond formed between the first and second fastening components 110, 122.

The display 12 includes a plurality of solid particles 148 suspended in the fluid 24. The solid particles 148 are made of an edible substance, such as coconut flakes or the like, and are temporarily dispersed in the fluid 24 and throughout the entire interior area 58 of the system 10 when the container 18 and/or system 10 is shaken by the user, for instance, before, during, and/or after the fluid 24 is being dispensed from the container 18. In this manner, the solid particles 148 are interactive with the user and complementary to the display 12 by cooperating therewith to provide the scene of the system 10.

Upon manufacture of the system 10 and to assemble such, the fluid 24, which is preferably a transparent or semi-transparent liquid such as an alcohol, water, soda, a combination thereof or the like, is added to the container 18. The solid particles 148, which is preferably an edible, non-harmful visible substance such as flakes of food (e.g., coconut flakes), flakes of a precious metal (e.g., gold leaf flakes), small pieces of spice, pepper, salt, seeds (e.g., cinnamon), and/or a combination thereof or the like, is added to the container 18 simultaneously with the fluid 24, before the fluid 24, or after the fluid is added to the container 18. The cap 20 is then securely fitting to the container to form a seal between the container 18 and the cap 20. It is foreseen that the cap 20 may be equipped with a tamper-indication mechanism, such as is known in the art.

The container 18 is then fitted to the stand 22 for storage of the fluid 24 and display of the display 12. The user may interact with the system 10 without removing the cap 20. To interact with the system 10, the user lifts the container 18, with or without the stand 22, and shakes the container 18, which causes the fluid 24 and the solid particles 148 to circulate within the entire interior area 58. The solid particles 148 are sized and shaped to simulate snow, such that, when the solid particles 148 are disrupted and caused to circulate throughout the entire interior area 58, the solid particles 148 in combination with the display 12 act as a snow globe and simulate a snowy scene. In other words, when the system 10 is shaken, it appears to be snowing within the container 18 and on the display 12 for a period of time, such as a few minutes. After the period of time, the solid particles 148 come to rest at the bottom of the container 18 and stay at rest until the container 18 is shaken or moved again. It is foreseen that the system 10 could be referenced as a beverage storing and dispensing snow globe without deviating from the scope of the present inventive concept.

To dispense the fluid 24, the cap 20 is removed from the container 18, at which point the fluid 24 may be dispensed into a drinking glass or the like. The cap 20 may then be refitted to the container 18, at which point the user may interact with the system 10 via shaking or the like to create the snowy scene

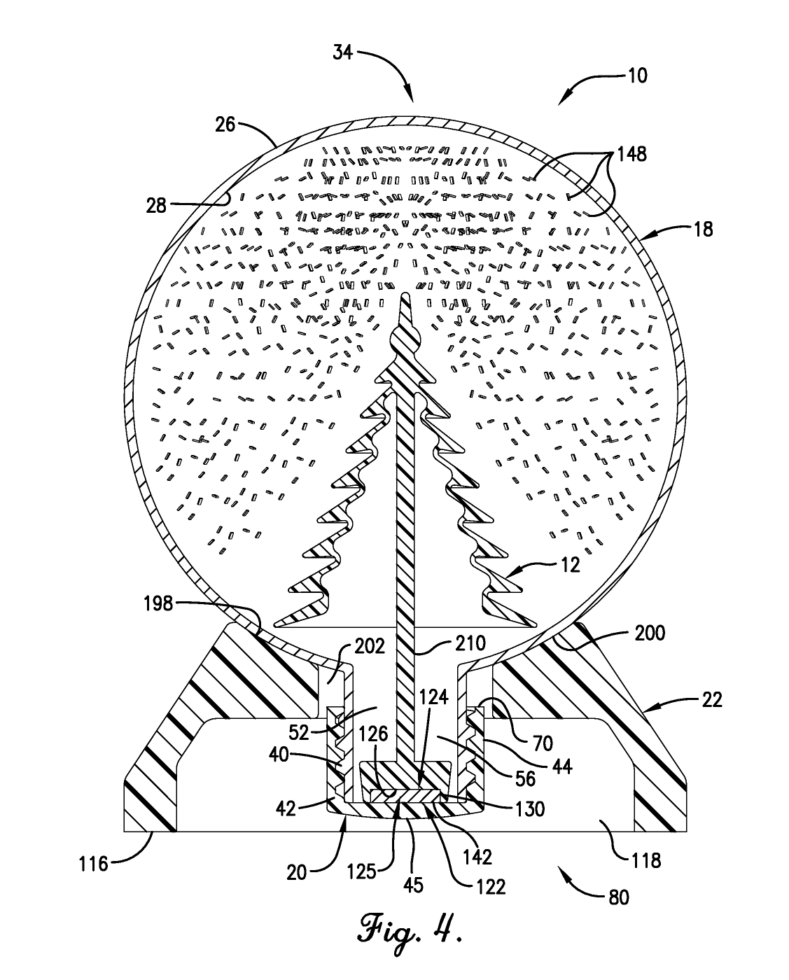

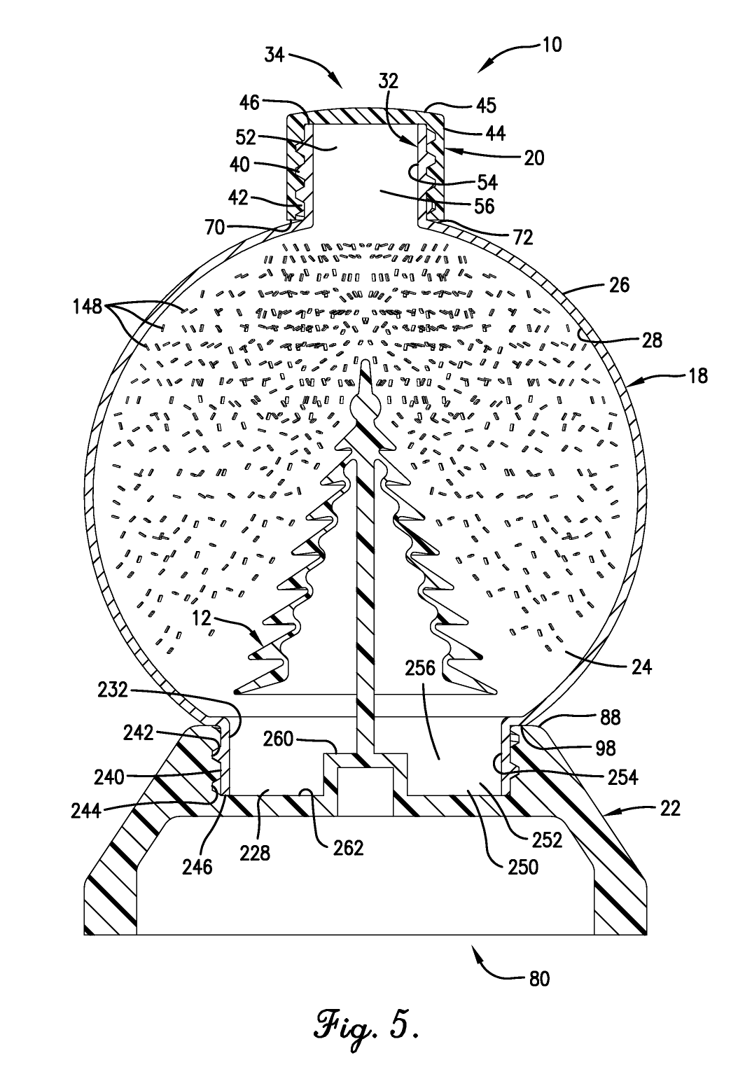

The container 18 and/or the stand 22 may be modified, as illustrated in FIGS. 4 and 5. FIG. 4 illustrates the upper end 34 of the container 18 having a continuously-curved surface with the neck 32 protruding from the lower end 80 of the container 18. The container 18 is stored on the stand 22 via gravity. The stand 22 has a concave container-abutment surface 198 that receives a convex stand-abutment surface 200, which is correspondingly sized and shaped. The neck 32 is received in an aperture 202 of the stand 22 and extends to the hollow interior 118, which adjoins with the aperture 202 of the stand 22. The aperture 202 is sufficiently sized and shaped to permit the cap 20 to pass therethrough when the cap 20 is fitted to the neck 32 of the container 18. It is foreseen, however, that the aperture 202 may be sized and shaped so that the cap 20 is not able to pass through the aperture 202 when the cap 20 is fitted to the neck 32 of the container 18, that is, the container 18 is locked to the stand 22 when the cap 20 is fitted to the container 18 and unlocked from the stand 22 when the cap 20 is removed from the container 18.

The display 12 has an elongated portion 210 that extends through the neck 32 so that the connector 125 is secured to the cap 20. The cap 20 of FIG. 4 is made of a magnetically-attractive material, such as metal or the like, to form a magnetic bond with the second fastening component 122. In this manner, the display 12 is removably secured to the cap 20 in FIG. 4. Alternatively, the display 12 may be permanently secured to the cap 20 via an adhesive or the like. The user interacts with the system 10 of FIG. 4 in the same manner is previously described except that the display 12 is removed from the container 18 when the cap 20 is removed from the container 18, for instance, when the user desires to dispense the fluid 24 therefrom.

FIG. 5 illustrates the lower end 80 of the container 18 having a second mouth 228 that is selectively closed by the stand 22 that operates as a second cap. An extension or second tubular neck 232 extends from the outer surface 28 of the container 18 at the lower end 80 thereof. The second neck 232 is sized and shaped to securely receive the stand 22 thereon so that a seal is formed between the container 18 and the stand 22 when the stand 22 is secured to the second neck 232. The second neck 232 includes an outer threaded surface 240 that is sized and shaped to mate with a correspondingly sized and shaped inner threaded surface 242 on an interior wall 244 of the stand 22, as illustrated in FIG. 5. The threaded surfaces 240, 242 are operable to further secure the seal between the container 18 and the stand 22 when the stand 22 is secured to the neck 232.

At a lowermost edge 246 of the second neck 232 is the second mouth 228, which defines a display-access opening 250. Depending from the lowermost edge 246 of the second neck 232 on an inside 252 of the second neck 232 is a smooth inner surface 254. The smooth inner surface 254 extends parallel to the outer threaded surface 240 from the lowermost edge 246 to the inner surface 28 of the container 18 and defines a second neck cavity 256 of the second neck 232. The second neck cavity 256 adjoins with the container cavity 30 to permit the display 22 stored in the container 18 to pass through the second mouth 228 to the outside of the system 10 for maintenance, replacement and/or exchange by the user. The cavities 30, 256 define an entire interior area 58 of the system 10.

The stand 22 includes a platform 260 that protrudes from a container-abutment surface 262. The platform 260 supports the display 12, which may be permanently mounted on the platform 260 via an adhesive or the like, integrally formed with the platform 260, or removably mounted to the platform 260 via a magnetic system, screwing, or the like. The user interacts with the system 10 of FIG. 5 in the same manner is previously described except that the display 12 is removed from the container 18 when the stand 22 is removed from the container 18, for instance, when the user desires to maintenance, replace, or exchange the display 12.

Accordingly, the present invention provides a unique system to store and dispense a beverage while permitting user interaction with the beverage and/or an interactive display.

Having now described the features, discoveries and principles of the general inventive concept, the manner in which the general inventive concept is constructed and used, the characteristics of the construction, and advantageous, new and useful results obtained; the new and useful structures, devices, tools, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

1. A beverage storage and dispensing system with display, the system comprising:
a container having an inner wall and an outer wall that cooperatively define a cavity, and at least one opening through the inner and outer walls operable to permit dispensing of the beverage from the container;
an ornamental structure housed within the cavity of the container and secured therein via a fastening means; and
a plurality of particles housed within the cavity of the container, the plurality of particles operable to circulate within the cavity and around the ornamental structure when the container is moved.

2. The system of claim 1, wherein the plurality of particles is edible and cooperates with the ornamental structure to provide a scene when the container is moved.

3. The system of claim 1, further comprising:
a stand having a container-receiving surface and a planar-bottom surface opposite to the container-receiving surface, the stand operable to support the container.

4. The system of claim 3, wherein the container-receiving surface is recessed within the stand.

5. The system of claim 1, wherein the fastening means is a magnetic system.

6. The system of claim 3, wherein the fastening means includes a first fastening component in the ornamental structure and a second fastening component in the container-receiving surface of the stand.

7. The system of claim 6, wherein the one of the first fastening component and the second fastening component is a magnet.

8. The system of claim 1, further comprising:
a second opening through the inner and outer walls on a side of the container opposite to the at least one opening, the second opening operable to permit removal of the ornamental structure therethrough; and
a stand having a container-receiving surface and a planar-bottom surface opposite to the container-receiving surface, the stand operable to support the container and close the second opening when the stand is secured to the container.

9. The system of claim 1, further comprising:
a closure sized and shaped to be fitted to the container so that a seal is formed when the closure is fitted to the container.

10. The system of claim 9, wherein the fastening means includes a first fastening component in the ornamental structure and a second fastening component in the closure.

11. A method of manufacturing a beverage storage and dispensing system with display, the method comprising the steps:
forming a container having an inner wall and an outer wall that cooperatively define a cavity;
forming at least one opening through the inner and outer walls operable to permit dispensing of the beverage from the container;
housing an ornamental structure housed within the cavity of the container and securing the ornamental structure within the cavity via a fastening means; and
housing a plurality of particles within the cavity of the container, the plurality of particles operable to circulate within the cavity and around the ornamental structure when the container is moved.

12. The method of claim 11, wherein the plurality of particles is edible and cooperates with the ornamental structure to provide a scene when the container is moved.

13. The method of claim 11, further comprising the step:
supporting the container on a stand having a container-receiving surface and a planar-bottom surface opposite to the container-receiving surface.

14. The method of claim 13, wherein the container-receiving surface is recessed within the stand.

15. The method of claim 11, wherein the fastening means is a magnetic system.

16. The method of claim 13, wherein the fastening means includes a first fastening component in the ornamental structure and a second fastening component in the container-receiving surface of the stand.

17. The method of claim 16, wherein the one of the first fastening component and the second fastening component is a magnet.

18. The system of claim 1, further comprising the steps:
forming a second opening through the inner and outer walls on a side of the container opposite to the at least one opening, the second opening operable to permit removal of the ornamental structure therethrough; and
providing a stand having a container-receiving surface and a planar-bottom surface opposite to the container-receiving surface, the stand operable to support the container and close the second opening when the stand is secured to the container.

19. A method of storing and dispensing a beverage, the method comprising the steps of:
storing a beverage in a cavity of a container, the container having an inner wall and an outer wall that cooperatively define the cavity;
storing an ornamental structure within the cavity of the container and securing the ornamental structure within the cavity via a fastening means; and
storing a plurality of particles within the cavity of the container, the plurality of particles operable to circulate within the cavity and around the ornamental structure when the beverage is dispensed from the container.
